(19) United States
(12) Patent Application Publication
(10) Pub. No.: US 2026/0359144 A1
(43) Pub. Date: Nov. 12, 2026

(54) METHOD FOR CHECKPOINTING, MIGRATING, AND RESUMING A PROCESS IN A CLOUD COMPUTING INFRASTRUCTURE

(71) Applicant: Cedana AI Inc., New York, NY (US)

(72) Inventors: William Foy, New York, NY (US); Neel Master, Santa Monica, CA (US); Brandon Smith, Wichita, KS (US); Niranjan Ravichandra, Washington, DC (US); Yash Anand, Pittsburgh, PA (US)

(21) Appl. No.: 19/355,885

(22) Filed: Oct. 10, 2025

Related U.S. Application Data
(63) Continuation-in-part of application No. 19/064,121, filed on Feb. 26, 2025.
Application No. 19/064,121 is a continuation-in-part of application No. 18/957,400, filed on Nov. 22, 2024.
(60) Provisional application No. 63/603,795, filed on Nov. 29, 2023.
(60) Provisional application No. 63/557,977, filed on Feb. 26, 2024.
(60) Provisional application No. 63/557,977, filed on Feb. 26, 2024.
(60) Provisional application No. 63/705,935, filed on Oct. 10, 2024.

(51) Int. Cl. G06F 9/50

(52) U.S. Cl. CPC G06F 9/5088; G06F 9/5038; G06F 9/5077

(57) ABSTRACT

A method includes, at a first node: intercepting calls from a process to a first set of application programming interfaces of a first set of graphics processing units in a first node; generating call records representing the calls; recording a target state of the process, the target state including the set of call records; and generating a checkpoint object representing the target state of the process. The method also includes, at a second node: accessing the checkpoint object; identifying the calls based on the call records in the checkpoint object; restoring the target state of the process at the second node by executing the calls to a second set of application programming interface of a second set of graphics processing units in the second node; and scheduling resumption of the process at the second node according to the target state of the process.

### CROSS-REFERENCE TO RELATED APPLICATIONS

This application is a continuation-in-part of U.S. patent application Ser. No. 19/064,121, filed on 26 Feb. 2025, which is a continuation-in-part of U.S. patent application Ser. No. 18/957,400, filed on 22 Nov. 2024, which claims the benefit of U.S. Provisional Application No. 63/705,935, filed on 10 Oct. 2024, U.S. Provisional Application No. 63/557,977, filed on 26 Feb. 2024, and U.S. Provisional Application No. 63/603,795, filed on 29 Nov. 2023, each of which is incorporated in its entirety by this reference.

U.S. patent application Ser. No. 19/064,121 claims the benefit of U.S. Provisional Application No. 63/705,935, filed on 10 Oct. 2024, and of U.S. Provisional Application No. 63/557,977, filed on 26 Feb. 2024, each of which is incorporated in its entirety by this reference.

This application is a continuation-in-part of U.S. patent application Ser. No. 18/957,400, filed on 22 Nov. 2024, which claims the benefit of U.S. Provisional Application No. 63/705,935, filed on 10 Oct. 2024, U.S. Provisional Application No. 63/557,977, filed on 26 Feb. 2024, and U.S. Provisional Application No. 63/603,795, filed on 29 Nov. 2023, each of which is incorporated in its entirety by this reference.

This application claims the benefit of U.S. Provisional Application No. 63/705,935, filed on 10 Oct. 2024, which is incorporated in its entirety by this reference.

### TECHNICAL FIELD

This invention relates generally to the field of cloud computing and, more specifically, to a new and useful method for checkpointing, migrating, and resuming a process in a cloud computing infrastructure within the field of cloud computing.

### BRIEF DESCRIPTION OF THE FIGURES

FIG. 1 is a flowchart representation of a method;

FIGS. 2A and 2B are flowchart representations of one variation of the method; and

FIG. 3 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. METHODS

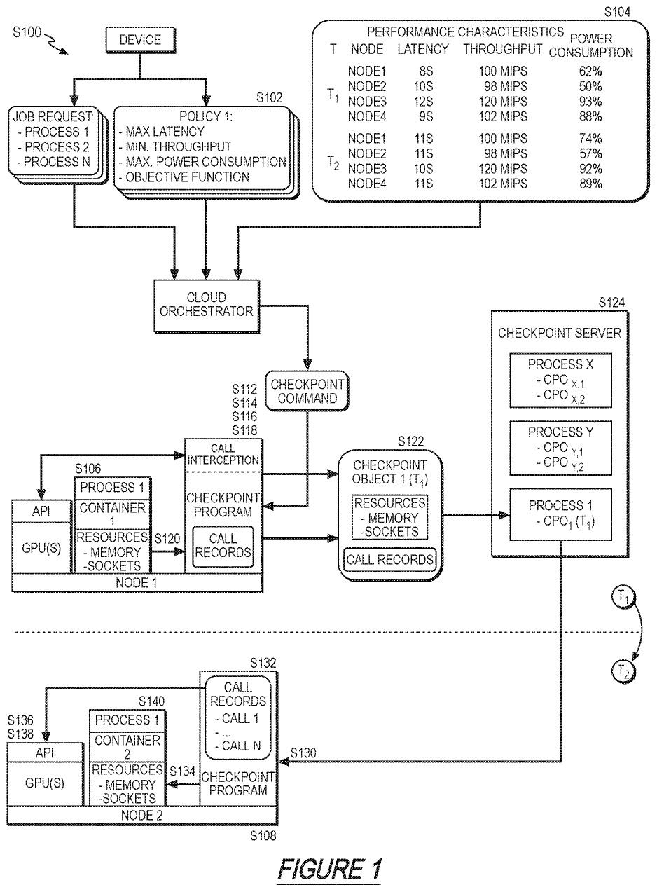

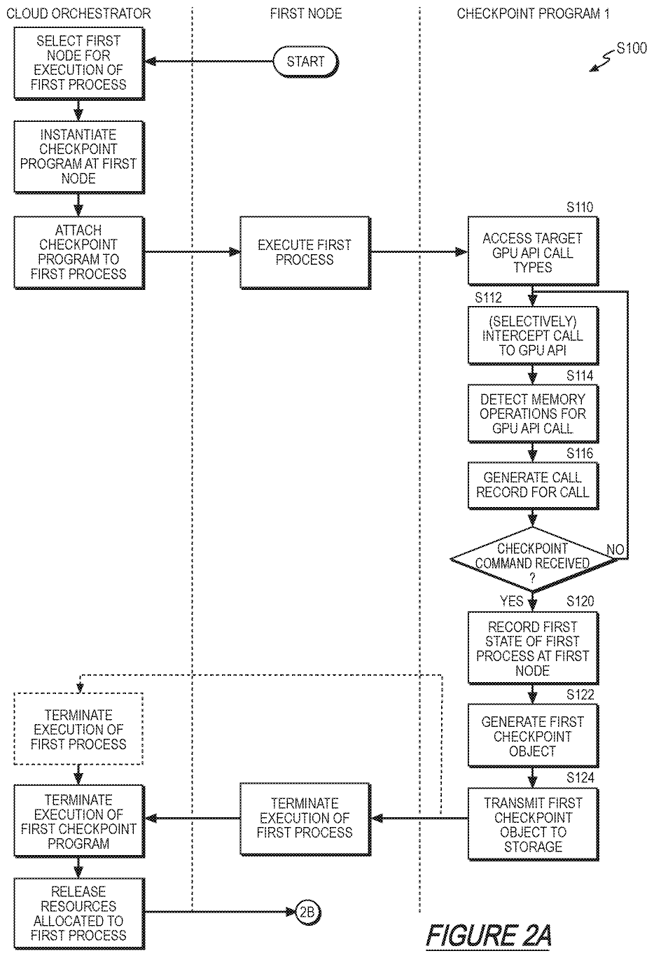

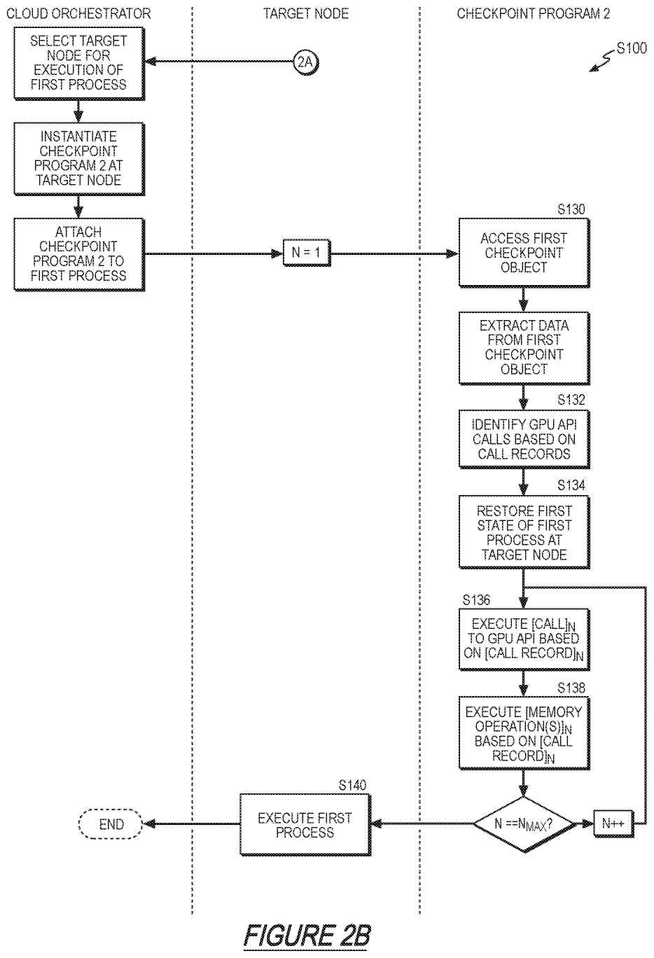

As shown in FIGS. 1, 2A, and 2B, a method S100 includes, during a first time period, at a first checkpoint program executing at a first node: intercepting a first call in a set of calls, by a first process, to a first application programming interface of a first graphics processing unit in the first node during execution of the first process at the first node in Block S112; detecting a first subset of memory operations, associated with the first call, in a first set of memory operations associated with the first graphics processing unit in Block S114; and generating a first call record, in a set of call records for the set of calls, representing the first call and the first subset of memory operations in Block S116.

The method S100 also includes, in response to reception of a checkpoint command: recording a first state of the first process executing at the first node in Block S120; generating a first checkpoint object representing the first state of the first process at the first time in Block S122; and storing the first checkpoint object in Block S124. The first state: represents a first set of resources, in the first node, allocated to the first process at a first time; and includes the set of call records.

The method S100 further includes, during a second time period succeeding the first time period, at a second checkpoint program executing at a second node: accessing the first checkpoint object in Block S130; identifying the set of calls and the first set of memory operations based on the set of call records in the first checkpoint object in Block S132; restoring the first state of the first process at the second node in Block S134 by executing the first call to a second application programming interface of a second graphics processing unit in the second node in Block S136 and executing the first set of memory operations in association with the second graphics processing unit in Block S138; and scheduling resumption of the first process at the second node according to the first state of the first process in Block S140.

### 1.1 Variation: Graphics Processing Unit Memory Snapshot

As shown in FIGS. 1, 2A, and 2B, one variation of the method S100 includes, during a first time period, at a first node: intercepting a set of calls from a first process to a first set of application programming interfaces of a first set of graphics processing units in the first node during execution of the first process at the first node in Block S112; and generating a set of call records representing the set of calls in Block S116.

This variation of the method S100 includes, in response to reception of a checkpoint command: recording a first state of the first process executing at the first node in Block S120; and generating a first checkpoint object representing the first state of the first process at the first time in Block S122. The first state: represents a first set of resources, in the first node, allocated to the first process at a first time; and includes the set of call records.

This variation of the method S100 further includes, during a second time period succeeding the first time period, at a second node: accessing the first checkpoint object in Block S130; identifying the set of calls based on the set of call records in the first checkpoint object in Block S132; restoring the first state of the first process at a second node in Block S134 by executing the set of calls to a second set of application programming interfaces of a second set of graphics processing units in a second node in Block S136; and scheduling resumption of the first process at the second node according to the first state of the first process in Block S140.

### 1.2 Variation: Process Checkpoint

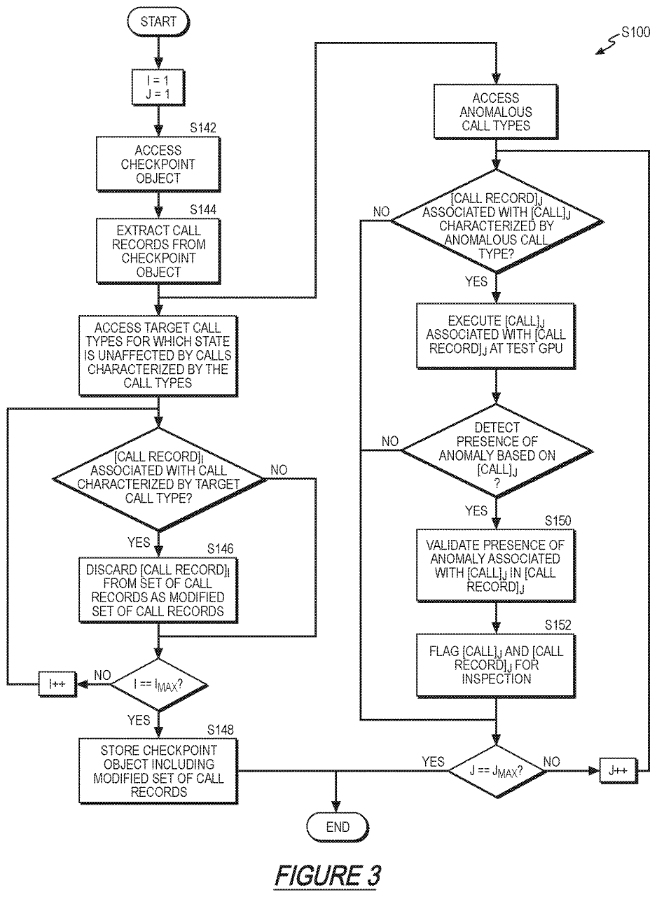

As shown in FIGS. 1, 2A, and 3, one variation of the method S100 includes: intercepting a set of calls from a first process to a first set of application programming interfaces of a first set of graphics processing units in a first node during execution of the first process at the first node in Block S112; detecting a set of memory operations associated with the set of calls to the first set of graphics processing units in Block S114; and generating a set of call records representing the set of calls and the set of memory operations in Block S116.

This variation of the method S100 includes, in response to reception of a checkpoint command: recording a first state of the first process executing at the first node in Block S120; generating a first checkpoint object representing the first state of the first process at the first time in Block S122; and storing the first checkpoint object in Block S124. The first state: represents a first set of resources, in the first node, allocated to the first process at a first time; and includes the set of call records.

### 2. APPLICATIONS

Generally, a computer system (hereinafter “the system”)—including or interfacing with a cloud infrastructure and/or a checkpoint server—can execute Blocks of the method S100: to receive a job (e.g., an inference job, a training job) from a device (e.g., a user device, an enterprise device); to generate a first workload instance on a first node of the cloud infrastructure; to deploy a checkpoint program and a process of the job onto the first workload instance; to monitor execution of the process at the first node via the checkpoint program; to suspend execution of the process at a target time; and to checkpoint the process at the target time.

More specifically, the system can execute Blocks of the method S100: to detect resources of the node allocated to the process at the target time; to record a state of the process representing these resources via the checkpoint program; to generate a checkpoint object representing the state of the process of the target time; to store the checkpoint object at a checkpoint server; and to terminate the first workload instance at the first node.

At a future time, the system can execute Blocks of the method S100: to generate a second workload instance on a second node of the cloud infrastructure; to access the checkpoint object representing the state of the process of the target time; to deploy the checkpoint program, the first process, and the checkpoint object on the second workload instance; to restore the state of the process on resources of the second node; and to resume execution of the process.

Accordingly, the system can execute Blocks of the method S100: to checkpoint a state of a process executing at a first node in the cloud infrastructure —without modification to the process—by identifying resources of the node allocated to the workload instance; to migrate the process to a second node in the cloud infrastructure; and to resume execution of the process by restoring the state onto resources of the second node. Therefore, the system can extend fine-grained (e.g., near-real-time) suspension, checkpointing, and resumption functionality: to existing processes without modification thereto; and/or to existing cloud infrastructures while preserving deployment and security workflows of these cloud infrastructures.

### 2.1 Graphics Processing Unit Process Migration

Additionally, the system can execute Blocks of the method S100: to track a sequence of calls (e.g., memory operations) by a process—via a checkpoint program during execution of the process on the first workload instance at a first node—to a first set of application programming interfaces of a first set of graphics processing units in the first node; and to record the sequence of calls in the checkpoint object representing a state of a process at a target time.

At a future time, the system can execute Blocks of the method S100: to generate a second workload instance on a second node; to access the checkpoint object representing the state of the process—and the sequence of calls—at the target time; to deploy the checkpoint program, the process, and the checkpoint object on the second workload instance; to restore the state of the process on resources of the second node; to sequentially execute the sequence of calls to a second set of application programming interfaces of a second set of graphics processing units (and/or other hardware) in the second node; and to resume execution of the process.

Therefore, by recording a sequence of calls by the process to different graphics processing units of the first node, the system can execute Blocks of the method S100 to later execute (or “replay”) this sequence of calls on the second node in order to restore the state of each of these graphics processing units while maintaining coherence of execution absent modification to the process and/or the workloads.

### 3. TERMINOLOGY

Generally, a “job” is referred to herein as a unit of work—received from a device—including a set of processes for execution.

Generally, a “process” is referred to herein as an instance of a program represented by a memory space, a file descriptor, and/or a process identifier (or a “PID”).

Generally, a “program” is referred to herein as a set of instructions executable by a computer.

Generally, a “container” is referred to herein as an isolated runtime environment.

Generally, “checkpoint” is referred to herein as capturing a state of a set of resources allocated to (or utilized by) a process executing at a node.

### 4. SYSTEM

Generally, as shown in FIG. 1, the system can include and/or interface with: a device (e.g., a user device, an enterprise device); a cloud computing subsystem (hereinafter “the cloud subsystem”) communicatively coupled to the device via a communication network (e.g., e.g., a local area network, a wide area network, the Internet); and a checkpoint server communicatively coupled to the cloud subsystem via the communication network.

The system can include additional devices communicatively coupled to the cloud subsystem via the communication network.

### 4.1 Cloud Subsystem

Generally, the cloud subsystem can include and/or interface with: a population of nodes (e.g., computing devices, bare-metal servers); and a cloud orchestrator (e.g., a computing device).

In one implementation, the population of nodes can include a heterogenous population of nodes. More specifically, the population of nodes can include a heterogenous population of nodes associated with a set of remote contract computing networks.

For example, the population of nodes can include: a first set of nodes associated with a first remote contract computing network; and a second set of nodes associated with a second remote contract computing network. In this example, the first set of nodes can include: a first subset of nodes located in a first geographic region (e.g., a first country); and a second subset of nodes located in a second geographic region (e.g., a second country).

In another implementation, the cloud subsystem receives a request—from the device—to execute a job (e.g., an inference job, a model training job, a rendering job, a gaming application) including a set of processes. In response to receiving the request, the cloud subsystem: executes the job; and returns a result to the device (or queues the result for download).

More specifically, the cloud orchestrator can: receive the job from the device; and schedule execution of a first process—in the set of processes—at a first node in the population of nodes. The first node can then execute the first process. For each process in the set of processes, the cloud subsystem can repeat the foregoing methods and techniques: to schedule execution of the process at a node (e.g., the first node, a second node) in the population of nodes; and to execute the process on the node.

Additionally, the cloud subsystem can monitor execution of a process on a node. For example, the cloud orchestrator can receive a set of execution characteristics representing a set of resources allocated to (or utilized by) the process executing at the node.

The cloud subsystem can return a result to the device in response to completion of the job.

### 4.2 Checkpoint Program

In one implementation, the system includes a checkpoint program (or a “daemon”) executing at a node in the population of nodes. For example, the node can execute the checkpoint program as a background process.

In another implementation, the checkpoint program: instantiates (or executes) at a node in the population of nodes; attaches to a process executing at the node; and monitors execution of the process at the node.

For example, the checkpoint program can: generate a set of execution characteristics representing resources allocated to the process during execution; and transmit the set of execution characteristics to the cloud orchestrator and/or the checkpoint server.

In this implementation, in response to receiving a checkpoint command (e.g., a remote procedure call), the checkpoint program: records state information associated with the process (or a “process state”); generates a checkpoint object representing the state information; and transmits the checkpoint object to the checkpoint server.

### 4.3 Checkpoint Server

Generally, the checkpoint server stores a population of checkpoint objects, each checkpoint object associated with a process in a population of processes. More specifically, the checkpoint server can store a group of checkpoint objects associated with a process in a set of processes representing a job.

In one implementation, the checkpoint server includes a data repository storing the set of checkpoint objects.

Additionally or alternatively, the checkpoint server can store the set of checkpoint objects in an external data repository (e.g., a remote data repository).

In another implementation, the checkpoint server communicates with a checkpoint program executing on a node. For example, the checkpoint server can transmit commands (e.g., remote procedure calls) to a checkpoint program executing at a node, such as: a first command to record a state of a process executing at the node as a checkpoint object; and a second command to restore the state of the process—extracted from the checkpoint object stored at the checkpoint server—at a target node.

### 5. PROCESS CHECKPOINTING

The method S100 includes: intercepting a set of calls from a first process to a set of application programming interfaces of a first set of graphics processing units in a first node during execution of the first process at the first node in Block S112; detecting a set of memory operations associated with the set of calls to the first set of graphics processing units in Block S114; and generating a set of call records representing the set of calls and the set of memory operations in Block S116.

The method S100 includes, in response to reception of a checkpoint command: recording a first state of the first process executing at the first node in Block S120; generating a first checkpoint object representing the first state of the first process at the first time in Block S122; and storing the first checkpoint object in Block S124. The first state: represents a first set of resources, in the first node, allocated to the first process at a first time; and includes the set of call records.

Generally, in Blocks S112, S116, S120, S122, and S124, the system can: execute a process of a job at a node; monitor execution of the process at the node; record a state of the process in response to a checkpoint command; generate a checkpoint object representing the state of the process; and store the checkpoint object at the checkpoint server.

Accordingly, the system can: detect node resources allocated to the process during execution; record a current state of the process in response to these node resources representing an idle state of the process; generate a checkpoint object representing the current state of the process; store the checkpoint object for later retrieval and resumption of the process from the current state; and release the node resources allocated to the process. Therefore, the system can automatically suspend the process in real-time (or near-real-time)—without modification to the process—for resumption at a different node and/or at a later time, thereby enabling more efficient allocation of node resources.

More specifically, the system can track a set of calls—by the process executing on a central processing unit(s) of the node—to an application programming interface (e.g., a runtime application programming interface, a driver application programming interface) of a graphics processing unit (or a set of graphics processing units) of the node.

For each call in the set of calls, the system can: intercept the call to the application programming interface of the graphics processing unit; generate a call record—in a set of call records—representing the call; and pass the call to the application graphics processing unit (or a controller) of the graphics processing unit for execution.

Accordingly, in response to receiving the checkpoint command, the system can: access the set of call records; generate a checkpoint object representing a state of the process—and a state of the graphics processing unit(s)—based on the set of call records; and store the checkpoint object for later retrieval. Therefore, the system can then: access the checkpoint object representing the state of the process based on the set of call records; and execute (or “replay”) the set of calls represented in the set of call records in order to restore the state of the graphics processing unit(s) in the node (or another node).

### 5.1 Scheduling and Execution

In one implementation, the cloud orchestrator: selects a first process in a set of processes of a job received from the device; selects a first node—in the population of nodes—at which to schedule the first process; instantiates (or executes) a first checkpoint program at the first node; allocates resources in the first node to the first process; and schedules execution of the first process at the first node.

More specifically, the cloud orchestrator (or the first node) can: instantiate the first checkpoint program as a background process executing at the first node; and attach the first checkpoint program to the first process identified by a first process identifier.

In another implementation, the first checkpoint program queries the checkpoint server for a checkpoint object associated with the first process.

For example, the first checkpoint program can transmit a first message requesting a checkpoint object associated with the first process identifier. In this example, the checkpoint server can transmit a second message indicating absence of a checkpoint object associated with the first process identifier.

The first node can then execute the first process.

### 5.1.1 Target Configuration

Generally, the system can access a policy—associated with a job (or a set of jobs)—specifying rules for deployment and execution of the job within the cloud subsystem.

More specifically, the cloud orchestrator can access the policy including a set of parameters corresponding to a set of target performance characteristics and representing orchestration rules for the job (and/or processes of the job).

For example, the cloud orchestrator can access the policy defining a target configuration for the job and/or for a process of the job. The target configuration can represent a set of parameters (e.g., resource parameters, price parameters, cost parameters) for executing the process.

Additionally or alternatively, the cloud orchestrator can access the policy defining an objective function representing a set of objectives (e.g., minimize response time, minimize total cost, maximize performance, minimize power consumption) associated with the job.

In one implementation, the cloud orchestrator can access the policy defining a target configuration representing a set of parameters—corresponding to a set of target performance characteristics and representing orchestration rules for the job—such as: a target processor capacity (e.g., a target central processing unit processing capacity, a target graphics processing unit processing capacity); a target processor throughput (e.g., central processing unit throughput, graphics processing unit throughput); a target processor utilization (e.g., a target central processing unit utilization, a target graphics processing unit utilization); a target processor type (e.g., a target central processing unit type, a target graphics processing unit type); a target processor interconnect; a target memory capacity (e.g., a target memory size, a target memory bandwidth); a target memory type; a target memory throughput; a target network interconnect; a target network bandwidth; a target network throughput; a target error rate; a target storage capacity; a target availability; a target latency; a target response time; a target locality (e.g., a target region, a target country); target security features (e.g., encryption, hardware security module); target regulatory features (e.g., privacy compliance); a target price (e.g., a target node spot price, a target node projected price, a target storage price); a target egress fee; and/or a target total cost; etc. The cloud orchestrator can access the policy defining a set of values (e.g., a target value, a maximum value, a minimum value, an average value) for each parameter in the set of parameters. Additionally, the cloud orchestrator can access the policy including the set of parameters defining a frequency (e.g., once per second, once per minute) at which to generate a checkpoint object for the job. The cloud orchestrator can access the policy defining a rank (or a priority) for each parameter in the set of parameters.

In another implementation, the cloud subsystem: accesses performance characteristics (e.g., real-time performance characteristics) of the set of nodes; and selects the first node at which to schedule the first process based on the objective function and/or correspondence between a first set of performance characteristics of the first node and the target configuration for the first process.

For example, the cloud subsystem can: access the target configuration corresponding to a set of target performance characteristics; access the first set of performance characteristics of the first node; and select the first node in response to the first set of performance characteristics falling within the set of target performance characteristics.

### 5.2 Workload Monitoring

Generally, the first checkpoint program can: monitor execution of the first process at the first node; derive a set of execution characteristics (e.g., processor utilization, memory utilization, data storage throughput, network throughput) representing resources of the first node allocated to the first process; and transmit the set of execution characteristics to the cloud orchestrator and/or the checkpoint server.

More specifically, the first checkpoint program can monitor (or track) the set of resources allocated to the first process at a target time during execution according to the first process identifier. For example, the first checkpoint program can monitor the set of resources allocated to the first process during execution by querying a control program (e.g., a host kernel, a guest kernel, a container manager) for resources associated with the first process identifier at the target time.

In one implementation, the first checkpoint program derives a set of execution characteristics representing resources allocated to the first process during execution. For example, the first checkpoint program can derive the set of execution characteristics representing: a current processor utilization attributed to execution of (or allocated to) the first process; and/or a current network throughput attributed to execution of the first process. The first checkpoint program transmits the set of execution metrics to the cloud orchestrator and/or the checkpoint server.

The first checkpoint program can periodically generate and transmit a set of execution characteristics according to a predefined frequency (e.g., once per second, once per ten seconds, once per minute).

### 5.2.1 Call Interception

In another implementation, the first checkpoint program executing at the first node: tracks a set of calls by the first process to a first application programming interface (e.g., a runtime application programming interface) of a first graphics processing unit in the first node; and tracks a set of memory operations (storage of data onto graphics processing unit memory, release of data from graphics processing unit memory)—associated with the first process—between a first central processing unit and the first graphics processing unit of the first node.

For example, the first checkpoint program can: intercept a first call to the runtime application programming interface of the first graphics processing unit by the first process in Block S112; detect a first subset of memory operations associated with the first call in Block S114; and generate a first call record representing the first call and the first subset of memory operations in Block S116.

More specifically, the first checkpoint program can store the first call, the first subset of memory operations, and/or the first call record in a shared memory segment accessible by a remote procedure call server communicatively coupled to the checkpoint program. Therefore, rather than transmitting the first call to the remote procedure call (or “RPC”) server via Transmission Control Protocol/Internet Protocol (or “TCP/IP”), the system can pass the first call between the checkpoint program and the remote procedure call server via the shared memory segment, thereby reducing latency between successive calls.

The first checkpoint program can pass the first call to a first controller (or the first application programming interface) of the first graphics processing unit for execution.

The first checkpoint program can repeat the foregoing methods and techniques for each call to the first application programming interface of the first graphics processing unit (and/or to an application programming interface(s) of another graphics processing unit(s)) during execution of the first process to generate a set of call records representing: the set of calls by the first process during a first time period; and the set of memory operations associated with the set of calls.

Then, in response to receiving a checkpoint command, the first checkpoint program can: record a first state of the first process executing at the first node S120; generate the first checkpoint object representing the first state of the first process executing at the first node at a first time in Block S122; and transmit the checkpoint object to the checkpoint server in Block S124. The first state represents: a first set of resources, in the first node, allocated to the first process at a first time; and the set of call records.

Accordingly, the cloud orchestrator can: instantiate the first checkpoint program at the first node; attach the first checkpoint program to the first process; and trigger the first checkpoint program to track calls—and memory operations associated with these calls—to the first application programming interface of the first graphics processing unit for storage in a checkpoint object. Therefore, the system can later execute these calls and memory operations stored in the checkpoint object in order to restore a state of the graphics processing unit(s) at a target node.

### 5.2.2 Calls to Multiple Graphics Processing Units

In one variation, the checkpoint program tracks a set of calls—by the first process executing on a central processing unit of the first node—to a first set of graphics processing units in the first node. The set of calls includes a subset of calls for each graphics processing unit in the first set of graphics processing units of the first node. The first checkpoint program also tracks a set of memory operations (e.g., storage of data onto graphics processing unit memory, release of data from graphics processing unit memory)—associated with the first process—between the central processing unit and each graphics processing unit in the first set of graphics processing units of the first node.

For example, the first checkpoint program can: intercept a first call to a first application programming interface of a first graphics processing unit in the first set of graphics processing units; detect a first subset of memory operations, associated with the first call, in a first set of memory operations associated with the first graphics processing unit; and generate a first call record representing the first call, the first subset of memory operations, and a first sequence number.

In this example, the first checkpoint program can then: intercept a second call to a second application programming interface of a second graphics processing unit in the first set of graphics processing units; detect a second subset of memory operations, associated with the second call, in a second set of memory operations associated with the second graphics processing unit; and generate a second call record representing the second call, the second subset of memory operations, and a second sequence number (e.g., a second sequence number succeeding the first sequence number). The first checkpoint program can pass the second call to a second controller (or the second application programming interface) of the second graphics processing unit for execution.

More specifically, the first checkpoint program can store the first call record and the second call record in a shared memory segment accessible by the RPC server communicatively coupled to the checkpoint program. Additionally or alternatively, the first checkpoint program can store, in the shared memory segment: the first call; the first subset of memory operations; the second call; and/or the second subset of memory operations.

The checkpoint program can repeat the foregoing methods and techniques for each call in the set of calls to the first set of graphics processing units during execution of the first process to generate a set of call records representing: the set of calls to the application programming interface(s) of the first set of graphics processing units during a first time period; the set(s) of memory operations associated with the set of calls; and/or a set of sequence numbers for the set of calls.

Accordingly, in response to receiving a checkpoint command, the first checkpoint program can: access the set of call records; generate a checkpoint object representing a state of the first process—and a state of each graphics processing unit in the first set of graphics processing units—based on the set of call records; and store the checkpoint object for later retrieval.

Therefore, by recording a sequence of calls by the process to different graphics processing units of the first node, the system can later execute (or “replay”) this sequence of calls on the first node (or another node) in order to restore the state of each of these graphics processing units while maintaining coherence of execution.

### 5.2.3 Selected Call Interception

In another variation, the first checkpoint program: accesses a set of target call types (e.g., based on a process type of the first process, based on a job type of the job) in Block S110; and selectively intercepts a call to the first application programming interface of the first graphics processing unit (or another application programming interface of another graphics processing unit) based on a call type of the call in Block S112.

For example, the checkpoint program can: access a set of target call types including a first call type; and selectively intercept a call to the first application programming interface of the first graphics processing unit in response to detection of the call characterized by the first call type.

Accordingly, by selectively intercepting calls to the first application programming interface of the first graphics processing unit, the system can thereby: reduce disk write overhead to generate call records; reduce execution time to complete the first process; and reduce a size of the first checkpoint object representing the set of call records.

### 5.2.3 Proxy Process

In one variation, the system executes the foregoing methods and techniques: to intercept a first call to a first application programming interface of the first graphics processing unit by the first process; to detect a first subset of memory operations associated with the first call; and to generate a first call record representing the first call and the first subset of memory operations.

In this variation, the system passes the first call to a proxy process that: executes the first call to the first graphics processing unit; and returns an output of the first call to the first process.

More specifically, the system can schedule the proxy process to execute (e.g., “spin,” “busy-wait”) for a wake window characterized by a first time duration. In response to expiration of the wake window characterized by the first time duration, the system can schedule the proxy process to enter a sleep mode for a sleep window characterized by a second time duration.

The system can repeat the foregoing methods and techniques: to schedule the proxy process to execute for a subsequent wake window characterized by the first time duration in response to expiration of the sleep window; and to schedule the proxy process to enter the sleep mode for a subsequent sleep window characterized by the second time duration in response to expiration of the subsequent wake window.

In one example, the system passes the first call to the proxy process during the wake window. In response to receiving the first call, the proxy process: executes the first call to the first graphics processing unit; and returns the output of the first call to the first process.

In another example, the system passes the first call to the proxy process during the sleep window. In response to execution of the proxy process during the subsequent wake window, the proxy process: accesses the first call; executes the first call to the first graphics processing unit; and returns the output of the first call to the first process.

The system can repeat the foregoing methods and techniques for each call in the set of calls.

Therefore, by scheduling the proxy process to enter the sleep mode for a sleep window, the system can reduce power consumption attributed to the proxy process waiting (e.g., “spinning,” “busy-waiting”) for a call to execute at a graphics processing unit.

### 5.3 Checkpoint Command

In one implementation, the system periodically checkpoints the first process at a predefined frequency (e.g., defined in the set of parameters).

For example, the system (e.g., the cloud orchestrator, the checkpoint server) can transmit a command (or a “checkpoint command”)—to the first checkpoint program—to checkpoint the first process based on a schedule associated with the first process. The schedule can define a frequency (e.g., once per ten seconds, once per minute, once per hour) at which to transmit a checkpoint command to the first checkpoint program.

In another implementation, the cloud orchestrator (or the checkpoint server): receives a set of execution characteristics from the checkpoint program; and transmits the checkpoint command based on the set of execution metrics.

More specifically, the cloud orchestrator can: detect a difference between the set of execution characteristics and a target configuration for the first process; and, in response to detecting the difference between the set of execution characteristics and the target configuration for the first process, transmit a checkpoint command to the checkpoint program.

Therefore, the system can: detect a deviation between target performance and actual performance of a process executing at a node; and automatically trigger real-time (or near-real-time) suspension of the process for resumption at a different node and/or at a later time in order to increase reliability of the process or a job including the process, to reduce a completion time of the process or the job, to reduce a total cost of completing a job including the process, and/or to execute load balancing across nodes in the cloud subsystem.

### 5.4 Checkpoint Object

In another implementation, in response to receiving the command to checkpoint the first process, the first checkpoint program: records a current state of the first process executing on the first node in Block S120; generates a checkpoint object representing the current state of the first process in Block S122; and transmits the checkpoint object to the checkpoint server (or another data repository) in Block S124.

More specifically, the first checkpoint program can record the current state of the first process executing at the first node, the current state: representing a set of resources in the first node allocated to the first process at a target time; and including the set of call records at the target time.

In one example, the first checkpoint program records the current state, including a set of data stored in memory (e.g., processor registers, memory address space) of the first node and allocated to the first process.

In this example, the first checkpoint program records the current state including: a first subset of data stored in a first set of processor registers in the set of resources allocated to the first process; and a second subset of data stored in a first memory device (e.g., an L1 cache, an L2 shared memory) in the set of resources allocated to the first process.

In another example, the first checkpoint program records the current state representing: a set of file descriptors associated with the first process; a set of file connections associated with the first process; and/or a set of network connections associated with the first process.

In another example, the first checkpoint program records the current state including the set of call records representing: the set of calls to a first set of application programming interfaces of the first set of graphics processing units in the first node; the set(s) of memory operations associated with the set of calls; and/or a set of sequence numbers for the set of calls.

In response to checkpointing the first process, the first node can continue executing the first process. Alternatively, the system can: terminate execution of the first process and the first checkpoint program at the first node; and release resources allocated to the first process.

### 6. PROCESS RESUMPTION

The method S100 includes: accessing the first checkpoint object in Block S130; identifying the set of calls and the set of memory operations based on the set of call records in the first checkpoint object in Block S132; restoring the first state of the first process at a second node in Block S134; and scheduling resumption of the first process at the second node according to the first state of the first process in Block S140.

The method S100 includes restoring the first state of the first process at the second node by: executing the set of calls to a second set of application programming interfaces of a second set of graphics processing units in a second node in Block S136; and executing the set of memory operations in association with the second set of graphics processing units in Block S138.

Generally, in Blocks S102, S104, S108, S130, S132, S134, S136, S138, and S140, the system can: select a target node (e.g., the first node, a second node different from the first node) in the population of nodes at which to schedule execution of the first process; transmit the first checkpoint object representing the first state of the first process at the first time to the target node; restore the first state of the first process at the target node; schedule execution of the first process at the target node; and resume execution of the first process at the target node.

In one implementation, the system executes the foregoing methods and techniques: to select a target node (e.g., the first node, a second node different from the first node) in the population of nodes at which to schedule execution of the first process; to instantiate a second checkpoint program at the target node; to access the first checkpoint object in Block S130; and to restore the first state of the first process—represented in the first checkpoint object—at the target node in Block S134.

In this implementation, the system: extracts the set of call records from the first checkpoint object; identifies the set of calls and the set(s) of memory operations based on the set of call records in Block S132; executes the set of calls to a second set of application programming interfaces of a second set of graphics processing units in the target node in Block S136; and executes the set(s) of memory operations in association with the second set of graphics processing units in Block S138.

For example, the system can: identify a first subset of synchronous calls in the set of calls; identify a second subset of asynchronous calls in the set of calls; sequentially execute the first subset of synchronous calls to the second set of application programming interfaces of the second set of graphics processing units; and batch execute the second subset of asynchronous calls to the second set of application programming interfaces.

Additionally, the checkpoint program can execute the foregoing methods and techniques: to extract the set of data—recorded from memory of the first node at the first time—from the first checkpoint objects; to restore the set of data into memory (e.g., processor registers, memory address space) of the target node; to restore the set of file descriptors associated with the first process at the target node; to restore the set of file connections associated with the first process at the target node; and/or to restore the set of network connections associated with the first process at the target node; etc.

Accordingly, the target node can then resume execution of the first process in response to: execution of the set of calls to the second set of application programming interfaces of the second set of graphics processing units; and execution of the set(s) of memory operations associated with the second set of graphics processing units.

### 6.1 Node Selection

In one implementation, during a second time period succeeding the first time period, the cloud orchestrator executes the foregoing methods and techniques: to select the target node at which to schedule the first process of the job; to instantiate a checkpoint program at the target node; and to attach the checkpoint program at the target node.

In one example, the cloud orchestrator executes the foregoing methods and techniques: to access performance characteristics of the population of nodes during the second time period; and to select the first node at which to schedule the first process in response to detecting correspondence between a second set of performance characteristics of the first node and the target configuration for the first process.

In another example, the cloud orchestrator executes the foregoing methods and techniques: to access performance characteristics of the population of nodes during the second time period; and to select the second node—different from the first node—at which to schedule the first process in response to detecting correspondence between a third set of performance characteristics of the second node and the target configuration for the first process.

In another example, the cloud orchestrator: calculates a first cost of resources on the first node to execute the first process during the second time period; calculates a second cost of resources on the second node to execute the first process during the second time period; and selects the second node for execution of the first process in response to the second cost falling below the first cost.

### 6.2 Checkpoint Object Access

In another implementation, in Block S130, the second checkpoint program accesses the first checkpoint object from the checkpoint server (or another data repository).

For example, the second checkpoint program can execute the foregoing methods and techniques to query the checkpoint server for a checkpoint object associated with the first process identifier identifying the first process.

In this example, the checkpoint server can: select the first checkpoint object stored in the data repository; and transmit the first checkpoint object to the target node.

Additionally or alternatively, in response to receiving the query for a checkpoint object associated with the process identifier, the checkpoint server can: generate a message indicating a location (e.g., an address) at which the first checkpoint object associated with the first process identifier is stored and accessible; and transmit the message to the checkpoint program.

The second checkpoint program can then retrieve (e.g., download) the first checkpoint object from the location in response to receiving the message from the checkpoint server.

### 6.3 State Restoration

In another implementation, in response to accessing the first checkpoint object, the second checkpoint program restores the first state of the first process—represented in the first checkpoint object—at the target node in Block S134.

More specifically, the second checkpoint program can: extract the set of data—recorded from memory of the first node at the first time—from the first checkpoint objects; restore the set of data into memory (e.g., processor registers, memory address space) of the target node; restore the set of file descriptors associated with the first process at the target node; restore the set of file connections associated with the first process at the target node; and/or restore the set of network connections associated with the first process at the target node; etc.

For example, the second checkpoint program can: extract the first subset of data—recorded from the first set of processor registers of the first node allocated to the first process at the first time—from the first checkpoint object; and load the first set of data into a second set of processor registers in the target node.

Additionally, the second checkpoint program can: extract the second subset of data—recorded from the first memory device of the first node allocated to the first process at the first time—from the first checkpoint object; and load the second set of data into a second memory device (e.g., an L1 cache, an L2 shared memory) in the target node.

The target node can then resume execution of the first process.

For example, the target node can resume execution of the first process based on the first set of data loaded into the second set of processor registers and the second set of data loaded into the second memory device in the target node.

Accordingly, the system can: suspend execution of a process of a job—such as an inference job—at a node at a first time, such as when user demand for inference falls below a demand threshold and/or other conditions (e.g., when resource utilization by the process falls below a utilization threshold, when a cost per unit of resource on the node exceeds a cost threshold); encapsulate a state of the process into a checkpoint object; and release the resources of the node allocated to the process in order to comply with a policy (e.g., a service level agreement, a target configuration) and/or to suspend ongoing cost accumulation attributed to the inference job.

Then, at a second time succeeding the first time—such as when user demand for inference exceeds the demand threshold and/or other conditions (e.g., when a cost per unit of resource on a target node falls below the cost threshold)—the system can: retrieve the checkpoint object; restore the state of the process onto resources of the target node; and resume execution from a point at which the process is suspended.

Therefore, the system can selectively suspend and resume execution of the process according to: time-varying resource utilization by the process; time-varying user demand for a result (e.g., an inference result) yielded by a job including the process; and/or time-varying availability or cost of node resources, thereby enabling more efficient allocation of node resources and reducing a total cost to complete the job while maintaining service level agreements.

### 6.3.1 Graphics Processing Unit State Restoration

In one implementation, in response to accessing the first checkpoint object representing the first state—of the first process—including the set of call records, the second checkpoint program: extracts the set of call records from the first checkpoint object; and identifies the set of calls and the set(s) of memory operations based on the set of call records in Block S132.

In this implementation, the second checkpoint program restores the first state of the first process at the target node by: executing (or “replaying”) the set of calls to a second set of application programming interfaces (or controllers) of a second set of graphics processing units in the target node in Block S136; and executing the set(s) of memory operations in association with the second set of graphics processing units in Block S138.

For example, the second checkpoint program can identify the set of call records including: a first call record representing a first call—to a first application programming interface of a first graphics processing unit in the first node—and a first sequence number assigned to the first call; and a second call record representing a second call, to a second application programming interface of a second graphics processing unit in the first node, and a second sequence number (e.g., the second sequence number succeeding the first sequence number) assigned to the second call.

In this example, the system: executes (or issues) the first call to a third application programming interface of a third graphics processing unit in the target node based on the first sequence number assigned to the first call; and, in response to executing the first call, executes (or issues) the second call to a fourth application programming interface of a fourth graphics processing unit in the target node based on the second sequence number assigned to the first call.

The second checkpoint program can repeat the foregoing methods and techniques for each call in the set of calls to sequentially execute calls (e.g., synchronous calls) to the second set of application programming interfaces of the second set of graphics processing units. Additionally, the second checkpoint program can batch execute asynchronous calls to the second set of application programming interfaces.

In this implementation, the second checkpoint program: executes a first set of memory operations in association with the third graphics processing unit in Block S136; and executes a second set of memory operations in association with the fourth graphics processing unit in Block S138.

The system repeats the foregoing methods and techniques for each set of memory operations represented in the set of call records to execute the set of memory operations in association with a graphics processing unit in the target node.

Additionally, the second checkpoint program can: restore the data in memory (e.g., processor registers, memory address space) of the target node; restore file descriptors, file connections, and/or network connections; etc.

In another implementation, the cloud orchestrator schedules resumption of the first process at the target node according to the first state of the first process in Block S140. The target node can then resume execution of the first process according to the first state.

### 6.4 Second Checkpoint

The system can execute the foregoing methods and techniques: to monitor execution of the first process at the target node; to derive a second set of execution characteristics—representing execution of the first process on the target node—to the cloud orchestrator and/or the checkpoint server; to generate a second checkpoint command based on the second set of execution characteristics; to record a second state of the first process executing at the target node, the second state representing a second set of resources in the target node allocated to the first process at a second time in response to the second checkpoint command; to generate a second checkpoint object representing the second state of the first process at the second time; and to store the second checkpoint object at the checkpoint server (or another data repository).

In one example, the second checkpoint program at the target node records the second state including a second set of data stored in memory (e.g., processor registers, memory address space) of the first node and allocated to the first process at the second time.

In this example, the second checkpoint program records the second state including: a third subset of data stored in the second set of processor registers in the second set of resources allocated to the first process; and a fourth subset of data stored in the second memory device in the second set of resources allocated to the first process.

In another example, the second checkpoint program records the second state representing: a second set of file descriptors associated with the first process at the second time; a second set of file connections associated with the first process at the second time; and/or a second set of network connections associated with the first process at the second time.

In another example, the second checkpoint program records the second state including a second set of call records representing: a second set of calls to the second set of application programming interfaces of the second set of graphics processing units in the target node; a set(s) of memory operations associated with the second set of calls; and/or a second set of sequence numbers for the second set of calls.

### 6.4.1 State Differential

In one variation, the system can: calculate a differential (or “diff”) between the second state of the first process and the first state of the first process; and generate the second checkpoint object representing the differential.

More specifically, the second checkpoint program at the target node: calculates a difference between the second state of the first process and the first state of the first process; and generates the second checkpoint object representing the difference between the second state of the first process and the first state of the first process.

In one example, the second checkpoint program at the target node: calculates a first difference between the third set of data stored in the second set of processor registers and the first set of data extracted from the first checkpoint object; calculates a second difference between the fourth set of data stored in the second memory device and the second set of data extracted from the first checkpoint object; and generates the second checkpoint object representing the first difference and the second difference.

In another example, the second checkpoint program at the target node: calculates a first difference between the second set of file descriptors associated with the first process at the second time and the set of file descriptors represented in the first checkpoint object; calculates a second difference between the second set of file connections associated with the first process at the second time and the set of file connections represented in the first checkpoint object; calculates a third difference between the second set of network connections associated with the first process at the second time and the set of network connections represented in the first checkpoint object; and generates the second checkpoint object representing the first difference, the second difference, and the third difference.

Accordingly, by generating the second checkpoint object representing the difference between the second state and the first state, the system can reduce a size of the second checkpoint object, thereby reducing communication overhead to communicate the second checkpoint object—and/or reducing overhead to store the second checkpoint object at the checkpoint server (or another data repository).

### 6.5 Subsequent Resumptions

The system can repeat the foregoing methods and techniques to suspend and/or resume execution of the first process on a node until completion of the first process.

For example, the system can execute the foregoing methods and techniques: to select a second target node at which to schedule the first process of the job; to instantiate a checkpoint program at the second target node; to attach the checkpoint program at the second target node; and to access the first checkpoint object and the second checkpoint object by querying the checkpoint server for a checkpoint object associated with the first process.

In this example, the system can sequentially: restore the first state of the first process represented by the first checkpoint object; and restore the second state of the first process based on the second checkpoint object representing the difference between the second state of the first process and the first state of the first process.

The system can repeat the foregoing methods and techniques for each process, in the set of processes, until completion of the job.

### 6.7 Example: Model Customization

In one example, the system: selects a first node at which to schedule execution of a first process in a first job for training a first model; executes the first process at the first node; records a first state of the first process—including a set of call records representing a set of calls, to a first set of application programming interfaces of a first set of graphics processing units in the first node, and sets of memory operations associated with the first set of graphics processing units based on the set of calls—in response to a checkpoint command; generates a first checkpoint object representing the first state of a first instance of the first process; and terminates execution of the first process at the first node.

In this example, the system: selects a second node at which to schedule execution of the first instance of the first process in the first job for training the first model; accesses the first checkpoint object at the second node; based on the first checkpoint object, restores the first state of the first process at the second node by executing the set of calls—to a second set of application programming interfaces of a second set of graphics processing units in the second node—and the sets of memory operations in association with the second set of graphics processing units; and schedules resumption (and resumes execution) of the first instance of the first process at the second node according to the first state of the first process.

Additionally, the system can: select a third node at which to schedule execution of a second instance of the first process in a second job for training a second model based on the first model; instantiate a third checkpoint program at the third node; access the first checkpoint object at the third node; based on the first checkpoint object, restore the first state of the first process at the third node by executing the set of calls—to a third set of application programming interfaces of a third set of graphics processing units in the third node—and the sets of memory operations in association with the third set of graphics processing units; and schedule execution of (and execute) a second instance of the first process at the third node according to the first state of the first process.

Therefore, the system can: execute the first process for training the first model; checkpoint execution of the first process in order to record a target state of the first process at a target time; resume execution of a first instance of the first process for training the first model; and instantiate a second instance of the first process—that resumes execution according to the target state of the first process at the target time—for training the second model based on the first model, thereby enabling customization of the second model absent re-execution of an entirety of the first process (or processes, of the first job, preceding the first process), reducing a completion time for training the second model, and reducing a total cost of training the second model.

### 6.8 Example: Grid Management

In another example, the system: receives an inference job and a policy, associated with the inference job, defining a set of parameters and an objective function (e.g., minimizing power consumption) in Block S102; accesses a first set of performance characteristics associated with the population of nodes for a first time interval in Block S104; and selects a first node—in the population of nodes and at which to schedule a first process of the inference job during the first time interval—based on the set of parameters, a first subset of performance characteristics associated with the first node, and the objective function in Block S106.

More specifically, the system can select the first node—in a first set of nodes in a first geographic region—characterized by a first power consumption (e.g., a power consumption at the first node, a power consumption at the first set of nodes) falling below a first power consumption threshold.

In this example, the system: instantiates the first process and a first checkpoint program on the first node; attaches the first checkpoint program to the first process; and schedules execution of the first process at the first node.

Then, the system accesses a second set of performance characteristics associated with the population of nodes during a second time interval succeeding the first time interval in Block S104. The second set of performance characteristics represents a second power consumption during execution of the first process at the first node in the second time interval.

More specifically, the system can access the second power consumption representing: a power consumption attributed to the first process at the first node; a power consumption at the first node; and/or a power consumption at the first set of nodes.

In response to the second power consumption exceeding a second power consumption threshold, the system: receives (or generates) a checkpoint command; selects the first process for migration in Block S106; records a first state of the first process—including a set of call records representing a set of calls, to a first set of application programming interfaces of a first set of graphics processing units in the first node, and sets of memory operations associated with the first set of graphics processing units based on the set of calls—in response to the checkpoint command and selection of the first process in Block S120; generates a first checkpoint object representing the first state of the first process in Block S122; and terminates execution of the first process at the first node in Block S124.

In this example, the system selects a second node, in the population of nodes and at which to schedule the first process during the second time interval, based on the set of parameters, a third subset of performance characteristics associated with the second node for the second time interval, and the objective function in Block S108.

More specifically, the system can select the second node—in a second set of nodes in a second geographic region—characterized by a third power consumption (e.g., a power consumption at the second node, a power consumption at the second set of nodes) falling below the first power consumption threshold.

In response to selecting the second node, the system: instantiates a second checkpoint program at the second node; accesses the first checkpoint object at the second node; based on the first checkpoint object, restores the first state of the first process at the second node, in Block S134, by executing the set of calls—to a second set of application programming interfaces of a second set of graphics processing units in the second node—in Block S136 and by executing the sets of memory operations in association with the second set of graphics processing units in Block S138; and schedules resumption (and resumes execution) of the first process at the second node according to the first state of the first process in Block S140.

Accordingly, the system can: pause execution of the inference job on the first node in response to excessive power consumption at the first node and/or the first set of nodes; migrate the inference job to the second node (and/or the second set of nodes) exhibiting power consumption falling within target (or nominal) levels; and resume execution of the inference job—on the second node—from a point at which the inference job is paused. Therefore, the system can dynamically migrate the inference job across a distributed fleet of data centers from a region exhibiting greater power demand (or carbon intensity) to a region exhibiting lesser power demand (or carbon intensity).

### 7. DISTRIBUTED PROCESSING

In one variation, the system executes the foregoing methods and techniques: to intercept a first call—in a set of calls by a first process—to a first application programming interface of a first graphics processing unit in a first node; to detect a first subset of memory operations associated with the first call; to generate a first call record representing the first call, the first subset of memory operations, and a first sequence number for the first call; and to dispatch (or pass, execute) the first call to the first application programming interface (or a first controller) of the first graphics processing unit for execution.

Additionally, the system can execute the foregoing methods and techniques: to intercept a second call, in the set of calls, to the first application programming interface of the first graphics processing unit; to detect a second subset of memory operations associated with the second call; and to generate a second call record representing the second call, the second subset of memory operations, and a second sequence number for the second call.

In this variation, rather than dispatching the second call to the first application programming interface (or the first controller) of the first graphics processing unit in the first node—which may be unavailable in response to the first call—for execution, the system dispatches (or executes) the second call to a second application programming interface (or a second controller) of a second graphics processing unit in a second node for execution.

In one example, rather than dispatch the second call to the first application programming interface of the first graphics processing unit characterized by a first graphics processing unit type (or architecture), the system dispatches (or executes) the second call to a second application programming interface of a second graphics processing unit characterized by a second graphics processing unit type different from the first graphics processing unit type.

In another example, the system: transforms the second call—characterized by a first call format corresponding to the first graphics processing unit type—into a transformed second call characterized by a second call format corresponding to the second graphics processing unit type; and dispatches (or executes) the transformed second call to the second application programming interface of the second graphics processing unit.

Therefore, the system can dispatch the set of calls to a set of graphics processing units (e.g., a heterogenous set of graphics processing units) across a set of different nodes in order to reduce completion time of the process or job, reduce cost of execution, and/or minimize resource waste (e.g., idle resources) in the cloud subsystem, etc.

In this variation, the system executes the foregoing methods and techniques: to record a target state of the first process—including the set of call records representing the set of calls, to a first set of application programming interfaces of a first set of graphics processing units in the first node, and sets of memory operations associated with the first set of graphics processing units based on the set of calls—in response to a checkpoint command; to generate a target checkpoint object representing the target state of the first process; and to terminate execution of the first process at the first node.

### 7.2 Distributed Processing: Resumption

In another variation, the system executes the foregoing methods and techniques: to access the target checkpoint object representing the target state of the first process based on the set of call records; to execute (or “replay”) the set of calls—represented in the set of call records—at a group of graphics processing units in a group of nodes; and to execute memory operations associated with the set of calls.

For example, a first checkpoint program executing at a first node can: dispatch (or execute) the first call to a first application programming interface (or a first controller) of a first graphics processing unit—characterized by a first graphics processing unit type—of the first node based on the first sequence number assigned to the first call; and execute the first subset of memory operations, associated with the first call, for the first graphics processing unit.

In this example, a second checkpoint program executing at a second node can: dispatch (or execute) the second call to a second application programming interface (or a second controller) of a second graphics processing unit—characterized by a second graphics processing unit type different from the first graphics processing unit type—of the second node based on the second sequence number assigned to the second call; and execute the second subset of memory operations, associated with the second call, for with the second graphics processing unit.

The system can repeat the foregoing methods and techniques for each call in the set of calls: to dispatch (or execute) the call to an application programming interface (or a controller) of a graphics processing unit of a second node based on a sequence number assigned to the call; and to execute a subset of memory operations, associated with the call, for the graphics processing unit.

The system can then resume execution of the first process at the group of nodes.

### 8. CONTAINER CHECKPOINT AND RESUMPTION

Generally, the system can instantiate a container—representing an isolated runtime environment—at a node. The node can include a container manager (e.g., a container controller, a container daemon): that manages a set of containers in the node; and that interfaces between a container, in the set of containers, and a host operating system kernel of the node.

The system can execute the foregoing methods and techniques: to select a first node at which to schedule the first process; to instantiate a first container at the first node; to instantiate a first checkpoint program at the first node; to allocate resources in the first node to the first container and/or the first process; to schedule execution of the first process within the first container at the first node; and to execute the first process within the first container.

In one implementation, the first checkpoint program executes the foregoing methods and techniques: to monitor execution of the first process within the first container instantiated at the first node; to derive a set of execution characteristics representing resources in the first node allocated to the first container and/or the first process during execution; and to transmit the set of execution characteristics to the checkpoint server.

For example, the first checkpoint program can monitor execution of the first process within the first container by querying the container manager for execution characteristics associated with the first process (e.g., according to the first process identifier).

In this implementation, the first checkpoint program executes the foregoing methods and techniques: to intercept a set of calls to a first set of application programming interfaces of a first set of graphics processing units allocated (or assigned) to the first container and/or the first process; to detect a set(s) of memory operations associated with the first set of graphics processing units; and to generate a set of call records representing the set of calls and the set(s) of memory operations.

In another implementation, during a first time period, the first checkpoint program executes the foregoing methods and techniques: to receive a checkpoint command from the checkpoint server; to record a first state of the first process executing within the first container at the first node, the first state representing a first set of resources in the first node assigned to the first container and allocated (or assigned) to the first process at a first time.

In one example, the first checkpoint program records the first state including a first set of data stored in a first memory (e.g., processor registers, memory address space) in the first set of resources assigned to the first container and allocated to the first process at the first time.

In this example, the first checkpoint program records the first state including: a first subset of data stored in a first set of processor registers in the first set of resources assigned to the first container and allocated to the first process; and a second subset of data stored in a first memory device (e.g., an L1 cache, an L2 shared memory) in the first set of resources assigned to the first container and allocated to the first process.

In another example, the first checkpoint program records the first state including the set of call records representing: the set of calls to the first set of application programming interfaces of the first set of graphics processing units, in the first node, allocated (or assigned) to the first container; and the set(s) of memory operations associated with the set of calls.

In this implementation, the first checkpoint program can execute the foregoing methods and techniques: to generate a first checkpoint object representing the first state of the first process at the first time; and to transmit the first checkpoint object to the checkpoint server (and/or another data repository).

The system can then terminate execution of the first process, the first checkpoint program, and/or the first container at the first node; and release the resources allocated to the first process, the first checkpoint program, and/or the first container.

In another implementation, during a second time period succeeding the first time period, the system can execute the foregoing methods and techniques: to select a target node (e.g., the first node, a second node different from the first node) in the population of nodes at which to schedule execution of the first process; to instantiate a second container at the target node; and to instantiate a second checkpoint program at the target node.

In this implementation, the second checkpoint program: accesses the first checkpoint object from the checkpoint server (or another data repository); and restores the first state of the first process—represented in the first checkpoint object—at the target node.

More specifically, the second checkpoint program can: extract the first set of data from the first checkpoint object; and restore the first state of the first process at the target node by loading the first set of data into a second memory in the target node for execution of the first process within a second container instantiated at the second node.

For example, the second checkpoint program can: extract the first subset of data—recorded from the first set of processor registers of the first node allocated to the first process at the first time—from the first checkpoint object; and load the first set of data into a second set of processor registers in the target node and assigned to the second container.

Additionally, the second checkpoint program can: extract the second subset of data—recorded from the first memory device of the first node allocated to the first process at the first time—from the first checkpoint object; and load the second set of data into a second memory device (e.g., an L1 cache, an L2 shared memory) in the target node and assigned to the second container.

Furthermore, the second checkpoint program can execute the foregoing methods and techniques: to extract the set of call records from the first checkpoint object; to identify the set of calls and the set(s) of memory operations based on the set of call records; to execute the set of calls to a second set of application programming interfaces of a second set of graphics processing units, in the target node, allocated (or assigned) to the second container; and to execute the set(s) of memory operations in association with the second set of second graphics processing units.

In another implementation, the second checkpoint program: generates a message triggering resumption of the first process within the second container; and transmits the message to a container manager executing at the target node.

The system schedules resumption of the first process within the second container at the target node according to the first state of the first process. The target node can then resume execution of the first process within the second container at the target node.

Therefore, the system can automatically suspend a process executing within a container in real-time (or near-real-time)—without modification to the process or the container—for resumption within a container instantiated at a different node and/or at a later time, thereby enabling more efficient allocation of node resources and/or reducing a total cost of completing a job including the process.

### 9. CALL RECORD MODIFICATION

In one implementation, in response to storing a checkpoint object—representing a set of call records—in the checkpoint server, the system: accesses the checkpoint object in the checkpoint server in Block S142; extracts the set of call records from the checkpoint object in Block S144; tunes the set of call records as a modified set of call records in Block S146, such as based on a call type of a call associated with a call record; and stores the checkpoint object representing the modified set of call records in Block S148.

In one example, the system: accesses a set of target call types—for which a state of a process (or a state of a graphics processing unit) is unaffected by calls characterized by the set of call types—including a first call type (e.g., a first call type that returns a name of a device); identifies a first subset of call records, in the set of call records, associated with calls characterized by the first call type; generates a modified set of call records excluding the first subset of call records by selectively discarding (or removing) the first subset of call records from the set of call records; and stores the checkpoint object representing the modified set of call records.

In this example, the system can execute the foregoing methods and techniques for each call type in the set of target call types: to identify a subset of call records in the set of call records associated with calls characterized by the call type; to selectively discard the subset of call records from the set of call records as a modified set of call records; and to store the checkpoint object representing the modified set of call records.

Therefore, by selectively removing call records associated with call types for which the state of the process (or a state of a graphics processing unit) is unaffected by calls characterized by these call types, the system can: reduce an amount of data that is stored in the checkpoint server; reduce an amount of data that is transmitted between the checkpoint server and a node; and/or reduce an amount of time to sequentially execute the set of calls at a node to restore a state of a graphics processing unit(s) (or a “cold start time”) during process resumption.

In another example, the system: detects a set of memory operations—represented in the set of call records—including a first subset of memory operations that store data in graphics processing unit memory and a second subset of memory operations that release data from graphics processing unit memory; and generates a modified set of memory operations representing a difference between the first subset of memory operations and the second subset of memory operations.

More specifically, the system can generate the modified set of memory operations representing a (net) state of data stored in graphics processing unit memory at a target time corresponding to the checkpoint command.

In this example, the system: generates a modified set of call records representing the modified set of memory operations; and stores the checkpoint object representing the modified set of call records.

Therefore, rather than sequentially executing various memory operations that store data into graphics processing unit memory and release data from graphics processing unit memory at a node during process resumption, the system can execute the modified set of memory operations that restores the net state of data stored in graphics processing unit memory at the target time corresponding to the checkpoint command, thereby reducing a cold start time of the process at the node and/or reducing an amount of data that is transmitted between the checkpoint server and the node.

### 10. CALL VULNERABILITIES AND TESTING

In one implementation, in response to storing a checkpoint object—representing a set of call records—in the checkpoint server, the system: accesses the checkpoint object in the checkpoint server in Block S140; extracts the set of call records from the checkpoint object in Block S142; detects an anomalous call associated with a target call record in the set of call records in Block S150; and flags the target call record and/or the checkpoint object for inspection in Block S152.

In one example, the system accesses a policy defining a set of anomalous call types (e.g., a call type associated with a known vulnerability). For each call type in the set of anomalous call types, the system: scans the set of call records for a subset of records associated the call type; and, in response to detecting the subset of records associated the call type, flags the subset of records for inspection.

In another example, in response to storing the checkpoint object associated with a job characterized by a first job type (e.g., an inference job), the system: identifies a set of nominal calls associated with and/or characteristic of the first job type (e.g., based on predefined list of calls, based on historical data representing sets of calls associated with the first job type); extracts the set of call records from the checkpoint object; detects an anomalous call—absent from the set of nominal calls—associated with a target call record in the set of call records; and flags the target call record and/or the checkpoint object for inspection.

Additionally or alternatively, the system can execute the foregoing methods and techniques to intercept a call to an application programming interface of a graphics processing unit. In response to absence of the call in the set of nominal calls, the system can: flag the call and/or a process associated with the call for inspection; quarantine the call and/or the process; and/or terminate execution of the process.

Therefore, the system can detect, flag, and/or quarantine an anomalous call to a graphics processing unit prior to execution of the anomalous call in order to increase security and/or stability during process execution.

In another implementation, in response to detecting an anomalous call represented in the set of call records, the system: executes the anomalous call to an application programming interface of a test graphics processing unit at a test node (e.g., a test graphics processing unit); and validates presence of an anomaly (e.g., a fault) associated with the anomalous call based on execution of the anomalous call at the test node.

### 11. CALL INTERCEPTION FOR OTHER HARDWARE

As described herein, the system executes Blocks of the method S100: to intercept a call to an application programming interface of a graphics processing unit; to generate a call record representing the call; to store a checkpoint object representing the call record; and to later execute (or “replay”) the call represented in the call record to restore a state of the graphics processing unit.

However, the system can similarly execute Blocks of the method S100: to intercept a call to another device (e.g., an interconnect between nodes, an interconnect between a central processing unit and a graphics processing unit(s), a field-programmable gate array, an application-specific integrated circuit, a network processor, a robotic device, a video random-access memory device); to generate a call record representing the call; to store a checkpoint object representing the call record; and to later execute (or “replay”) the call represented in the call record to restore a state of the device.

For example, the system can: intercept a call, in a set of calls by a first process, to a first interconnect device associated with a first node during execution of the first process at the first node; generate a call record, in a set of call records, representing the call; store a checkpoint object representing a first state of the first process including the set of call records; and later restore the first state of the first process at a second node by executing the call to a second interconnect associated with the second node.

### 11. VARIATION: GRAPHICS PROCESSING UNIT MEMORY SNAPSHOT

In one variation, during a first time period, the system executes the foregoing methods and techniques: to select a first node at which to schedule a first process of a job; to instantiate (or execute) a first checkpoint program at the first node; to allocate resources in the first node to the first process; and to schedule execution of the first process at the first node.

In this variation, the first checkpoint program executes the foregoing methods and techniques: to intercept a set of calls from the first process to a first set of application programming interfaces of a first set of graphics processing units in the first node during execution of the first process at the first node in Block S112; and to generate a set of call records representing the set of calls in Block S116.

In response to reception of a checkpoint command, the first checkpoint program: detects a set of data stored in memory in each graphics processing unit in the first set of graphics processing units in Block S118; and records a first state of the first process executing at the first node in Block S120. The first state: represents a first set of resources, in the first node, allocated to the first process at a first time; and includes the set of call records and the set of data stored in memory in each graphics processing unit in the first set of graphics processing units.

More specifically, for each graphics processing unit in the first set of graphics processing units, the system (e.g., the first checkpoint program) can: detect a set of data stored in memory in the graphics processing unit by executing (or dispatching) a call—to an application programming interface of the graphics processing unit—that returns the set of data stored in memory in the graphics processing unit; and record the first state including the set of data.

For example, for a first graphics processing unit in the first set of graphics processing units, the first checkpoint program can: detect a first set of data stored in memory in the first graphics processing unit by executing (or dispatching) a first call—to a first application programming interface of the first graphics processing unit—that returns the first set of data stored in memory in the graphics processing unit; and record the first state including the first set of data.

The first checkpoint program repeats the foregoing methods and techniques for each graphics processing unit in the first set of graphics processing units: to detect a set of data stored in memory in the graphics processing unit; and to record the first state including the set of data.

In this variation, the first checkpoint program executes the foregoing methods and techniques: to generate a first checkpoint object representing the first state of the first process at the first time in Block S122; and to transmit the first checkpoint object to the checkpoint server (or another data repository) in Block S124. The system can: terminate execution of the first process and the first checkpoint program at the first node; and release resources allocated to the first process.

In another variation, during a second time period succeeding the first time period, the system executes the foregoing methods and techniques: to select a second node at which to schedule execution of the first process; to instantiate a second checkpoint program at the target node; to access the first checkpoint object in Block S130; to restore the first state of the first process—represented in the first checkpoint object—at the second node in Block S134; and to schedule resumption of the first process at the second node according to the first state of the first process in Block S140.

More specifically, the system can restore the first state of the first process at the second node by: executing the set of calls to a second set of application programming interfaces of a second set of graphics processing units in a second node in Block S136; and loading sets of data in memory in the second set of graphics processing units in Block S138.

For example, the second checkpoint program can load the first set of data—stored in memory in the first graphics processing unit—into memory in a second graphics processing unit in the second set of graphics processing units.

In this example, the second checkpoint program can repeat the foregoing methods and techniques for each set of data to load the set of data into memory in a graphics processing unit in the second set of graphics processing units.

### 12. DISCLAIMERS

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during a first time period, at a first checkpoint program executing at a first node:
intercepting a first call, in a set of calls by a first process, to a first application programming interface of a first graphics processing unit in the first node during execution of the first process at the first node;
detecting a first subset of memory operations, associated with the first call, in a first set of memory operations associated with the first graphics processing unit;
generating a first call record, in a set of call records for the set of calls, representing the first call and the first subset of memory operations; and
in response to reception of a checkpoint command:
recording a first state of the first process executing at the first node, the first state:
representing a first set of resources, in the first node, allocated to the first process at a first time; and
comprising the set of call records;
generating a first checkpoint object representing the first state of the first process at the first time; and
storing the first checkpoint object; and
during a second time period succeeding the first time period, at a second checkpoint program executing at a second node:
accessing the first checkpoint object;
identifying the set of calls and the first set of memory operations based on the set of call records in the first checkpoint object;
restoring the first state of the first process at the second node by:
executing the first call to a second application programming interface of a second graphics processing unit in the second node; and
executing the first set of memory operations in association with the second graphics processing unit; and
scheduling resumption of the first process at the second node according to the first state of the first process.

2. The method of claim 1:
wherein generating the first call record comprises generating the first call record representing a first sequence number, in a set of sequence numbers, for the first call;
further comprising:
intercepting a second call, in the set of calls by the first process, to a third application programming interface of a third graphics processing unit in the first node during execution of the first process at the first node;
detecting a second subset of memory operations, associated with the second call, in a second set of memory operations associated with the third graphics processing unit; and
generating a second call record, in the set of call records, representing:
the second call;
the second subset of memory operations; and
a second sequence number, in the set of sequence numbers, for the second call; and
wherein restoring the first state of the first process at the second node comprises:
executing the second call to a fourth application programming interface of a fourth graphics processing unit in the second node in response to executing the first call to the second application programming interface according to the set of sequence numbers; and
executing the second set of memory operations in association with the fourth graphics processing unit.

3. The method of claim 1, further comprising, during the first time period:
intercepting a second call, in the set of calls by the first process, to the first application programming interface of the first graphics processing unit in the first node during execution of the first process at the first node;
generating a second call record, in the set of call records, representing the second call; and
executing the second call to a third application programming interface of a third graphics processing unit in a third node.

4. The method of claim 3:
wherein intercepting the second call comprises intercepting the second call to the first application programming interface of the first graphics processing unit characterized by a first graphics processing unit type, the second call characterized by a first format corresponding to the first graphics processing unit type; and
wherein dispatching the second call to the third application programming interface comprises:
transforming the second call into a transformed second call characterized by a second format corresponding to a second graphics processing unit type different from the first graphics processing unit type; and
executing the transformed second call to a third application programming interface of a third graphics processing unit in a third node, the third graphics processing unit characterized by the second graphics processing unit type.

5. The method of claim 3, wherein restoring the first state of the first process at the second node comprises executing the second call to the second application programming interface of the second graphics processing unit in the second node.

6. The method of claim 1, wherein intercepting the first call to the first application programming interface comprises:
accessing a set of target call types comprising a first call type; and
in response to detection of the first call characterized by the first call type, selectively intercepting the first call to the first application programming interface.

7. The method of claim 1:
wherein recording the first state of the first process comprises recording the first state of the first process executing within a first container representing an isolated runtime environment instantiated at the first node, the first state representing the first set of resources assigned to the first container and allocated to the first process at the first time;
wherein restoring the first state of the first process comprises executing the first call to the second application programming interface of the second graphics processing unit assigned to a second container representing an isolated runtime environment instantiated at the second node; and
wherein scheduling resumption of the first process at the second node comprises scheduling resumption of the first process within the second container.

8. The method of claim 1:
wherein generating the first checkpoint object comprises generating the first checkpoint object representing the first state of a first instance of the first process in a first job for training a first model;
wherein scheduling resumption of the first process at the second node comprises scheduling resumption of the first instance of the first process at the second node according to the first state of the first process; and
further comprising, at a third checkpoint program executing at a third node:
restoring the first state of the first process at the third node by:
executing the first call to a third application programming interface of a third graphics processing unit in the third node; and
executing the first set of memory operations in association with the third graphics processing unit; and
scheduling execution of a second instance of the first process, in a second job for training a second model based on the first model, at the third node according to the first state of the first process.

9. The method of claim 1:
wherein storing the first checkpoint object comprises storing the first checkpoint object in a checkpoint server; and
further comprising, during a third time period succeeding the first time period:
accessing the first checkpoint object stored in the checkpoint server;
extracting the set of call records from the first checkpoint object;
accessing a set of target call types comprising a first call type;
identifying a first subset of call records, in the set of call records, associated with calls characterized by the first call type;
generating a modified set of call records by discarding the first subset of call records from the set of call records; and
storing the first checkpoint object representing the modified set of call records.

10. The method of claim 1:
wherein storing the first checkpoint object comprises storing the first checkpoint object in a checkpoint server; and
further comprising, during a third time period succeeding the first time period:
accessing the first checkpoint object in the checkpoint server;
extracting the set of call records from the first checkpoint object;
detecting the first set of memory operations represented in the set of call records, the first set of memory operations comprising:
a first subset of memory operations, in the first set of memory operations, that store data in graphics processing unit memory; and
a second subset of memory operations, in the first set of memory operations, that release data in graphics processing unit memory;
generating a modified first set of memory operations representing a difference between the first subset of memory operations and the second subset of memory operations;
generating a modified set of call records representing the modified first set of memory operations; and
storing the checkpoint object representing the modified set of call records.

11. The method of claim 1:
wherein storing the first checkpoint object comprises storing the first checkpoint object in a checkpoint server; and
further comprising, during a third time period succeeding the first time period:
accessing the first checkpoint object in the checkpoint server;
extracting the set of call records from the first checkpoint object;
detecting an anomalous call associated with a target call record in the set of call records; and
flagging the target call record and the first checkpoint object for inspection.

12. The method of claim 11, wherein detecting the anomalous call comprises:
executing the anomalous call to an application programming interface of a test graphics processing unit at a test node; and
validating presence of an anomaly associated with the anomalous call based on execution of the anomalous call at the test node.

13. The method of claim 1:
further comprising:
intercepting a second call, in the set of calls, to a first interconnect device associated with the first node during execution of the first process at the first node; and
generating a second call record, in the set of call records, representing the second call;
wherein restoring the first state of the first process comprises executing the second call to a second interconnect associated with the second node.

14. The method of claim 1:
wherein recording the first state of the first process comprises recording the first state comprising a first set of data stored in a first memory in the first set of resources; and
wherein restoring the first state of the first process comprises loading the first set of data into a second memory in the second node.

15. The method of claim 1:
further comprising:
accessing a first set of execution characteristics representing a first power consumption attributed to the first process during execution of the first process at the first node; and
selecting the first process for migration based on the first power consumption;
wherein recording the first state of the first process comprises recording the first state of the first process in response to:
selection of the first process for migration; and
reception of the checkpoint command; and
further comprising:
accessing a policy for a job comprising the first process, the policy defining a set of parameters and an objective function;
accessing a second set of performance characteristics representing a second power consumption associated with a second set of nodes comprising the second node; and
selecting the second node, in the second set of nodes, for the first process based on:
the set of parameters;
the set of performance characteristics; and
the objective function.

16. A method comprising:
during a first time period, at a first node:
intercepting a set of calls from a first process to a first set of application programming interfaces of a first set of graphics processing units in the first node during execution of the first process at the first node;
generating a set of call records representing the set of calls; and
in response to reception of a checkpoint command:
recording a first state of the first process executing at the first node, the first state:
representing a first set of resources, in the first node, allocated to the first process at a first time; and
comprising the set of call records; and
generating a first checkpoint object representing the first state of the first process at the first time; and
during a second time period succeeding the first time period, at a second node:
accessing the first checkpoint object;
identifying the set of calls based on the set of call records in the first checkpoint object;
restoring the first state of the first process at a second node by executing the set of calls to a second set of application programming interfaces of a second set of graphics processing units in a second node; and
scheduling resumption of the first process at the second node according to the first state of the first process.

17. The method of claim 16:
wherein recording the first state of the first process comprises:
detecting a first set of data stored in memory in a first graphics processing unit in the first set of graphics processing units; and
recording the first state comprising the first set of data; and
wherein restoring the first state of the first process at the second node comprises restoring the first state of the first process at the second node by loading the first set of data in memory in a second graphics processing unit in the second set of graphics processing units.

18. The method of claim 16:
wherein identifying the set of calls comprises:
identifying a first subset of synchronous calls in the set of calls; and
identifying a second subset of asynchronous calls in the set of calls; and
wherein executing the set of calls to the second set of application programming interfaces comprises:
sequentially executing the first subset of synchronous calls to application programming interfaces in the second set of application programming interfaces; and
batch executing the second subset of asynchronous calls to application programming interfaces in the second set of application programming interfaces.

19. A method comprising:
intercepting a set of calls from a first process to a first set of application programming interfaces of a first set of graphics processing units in a first node during execution of the first process at the first node;
detecting a set of memory operations associated with the set of calls to the first set of graphics processing units;
generating a set of call records representing the set of calls and the set of memory operations; and
in response to reception of a checkpoint command:
recording a first state of the first process executing at the first node, the first state:
representing a first set of resources, in the first node, allocated to the first process at a first time; and
comprising the set of call records;
generating a first checkpoint object representing the first state of the first process at the first time; and
storing the first checkpoint object.

20. The method of claim 19, further comprising:
accessing the first checkpoint object;
identifying the set of calls and the set of memory operations based on the set of call records in the first checkpoint object;
restoring the first state of the first process at a second node by:
executing the set of calls to a second set of application programming interfaces of a second set of graphics processing units in the second node; and
executing the set of memory operations in association with the second set of graphics processing units; and
scheduling resumption of the first process at the second node according to the first state of the first process.
